(19) United States
(12) Patent Application Publication
(10) Pub. No.: US 2026/0225812 A1
(43) Pub. Date: Aug. 6, 2026

(54) SYSTEMS AND METHODS OF ITEM INDUCTION WITHIN AN AUTOMATED STORAGE AND RETRIEVAL SYSTEM

(71) Applicant: Walmart Apollo, LLC, Bentonville, AR (US)

(72) Inventor: Timothy M. Szaflarski, Washington, DC (US)

(21) Appl. No.: 19/465,764

(22) Filed: Jan. 30, 2026

Related U.S. Application Data
(60) Provisional application No. 63/752,128, filed on Jan. 31, 2025.

(51) Int. Cl. B65G 1/137; B65G 1/04; G06Q 10/087

(52) U.S. Cl. CPC B65G 1/1378; B65G 1/0492; B65G 1/1371; G06Q 10/087

(57) ABSTRACT

Systems, apparatuses, and methods are provided for item induction into an automated storage and retrieval system. Some embodiments include a storage structure storing a plurality of totes, a transport system configured to move the totes within the storage structure and to and from workstations, a buffer storage, and a control system. The control system receives an identifier associated with an order indicating that items of the order have been placed into the buffer storage, selects a tote for the order based on associated order information and available space within the totes, and causes the transport system to deliver the selected tote to a workstation. Instructions are provided to transfer the buffered items into the tote, after which the transport system returns the tote and items to the storage structure. Partially filled totes associated with the order may be preferentially selected.

### CROSS-REFERENCE TO RELATED APPLICATIONS

This application claims the benefit of U.S. Provisional Application No. 63/752,128, filed January 31, 2025, which is incorporated herein by reference in its entirety.

### BACKGROUND

Automated storage and retrieval systems (ASRS) are increasingly used in retail and order-fulfillment facilities to store, retrieve, and transport items associated with customer orders. Such systems commonly employ storage structures housing a large number of containers or totes, along with automated transport mechanisms such as mobile robots, shuttles, or lifts that move the totes between storage locations and processing workstations. Conventional item-induction approaches often require assigning a new empty tote for each group of items inducted, even when partially filled totes associated with the same order already exist within the storage structure. This can increase tote usage, robot traffic, storage congestion, and order-retrieval latency, thereby reducing the efficiency of such conventional approaches.

### BRIEF DESCRIPTION OF DRAWINGS

Various examples will be described below with reference to the following figures:

FIG. 1 is a schematic perspective view of a portion of a retail facility including an automated storage and retrieval system in accordance with some embodiments;

FIG. 2 is a schematic view of a workstation system in accordance with some embodiments;

FIG. 3 is a schematic view of the workstation system of FIG. 2 further illustrating interaction with a transport system in accordance with some embodiments;

FIG. 4 is a block diagram illustrating a system in accordance with some embodiments;

FIG. 5A is a schematic representation of a tote associated with an order, illustrating items contained within the tote;

FIG. 5B is a schematic representation of a partially filled tote containing a subset of items associated with an order;

FIG. 5C is a schematic representation of an empty tote;

FIG. 6 is a flow diagram illustrating an example process in accordance with some embodiments; and

FIG. 7 is a flow diagram illustrating an example process in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Although certain actions and/or steps may be described or depicted in a particular order of occurrence, those actions and/or steps are not limited to that order and may be performed in a different order or occurrence. The terms and expressions used herein have the ordinary technical meaning as is accorded to such terms and expressions except where different specific meanings have otherwise been set forth herein.

### DETAILED DESCRIPTION

Generally speaking, pursuant to various embodiments, systems, apparatuses, and methods are provided herein useful to item induction into an automated storage and retrieval system (ASRS). In some embodiments, a system for item induction to an automated storage and retrieval system includes: a storage structure storing a plurality of totes; a transport system configured to move the totes within the storage structure and to and from workstations; a workstation connected to the storage structure; a buffer storage; and a control system comprising a control circuit that: receives a first identifier associated with a first order indicating that items in the first order have been placed into the buffer storage; selects, in response to receiving the first identifier, a first tote within the storage structure for the first order based on associated order information and space availability information of the plurality of totes, wherein a tote database stores the associated order information, storage location information, and the space availability information of the plurality of totes, and wherein a space availability of a tote is based on space occupied by the items stored in the tote; causes the transport system to retrieve the first tote from the storage structure and transport the first tote to the workstation based on a storage location of the first tote; provides instructions to transfer the items in the first order from the buffer storage to the first tote after the first tote arriving at the workstation; and causes the transport system to transfer the first tote, along with the items in the first order, from the workstation to the storage structure for storage.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

In one aspect, and without limitation, this disclosure may involve generally a facility, such as an order fulfillment facility, which may include multiple mobile robots that operate to pick and transfer containers in the context of an automated storage and retrieval system. In one form, mobile robots move about a storage structure and retrieve containers of goods (which may also be referred to as totes) that are stored in specific storage locations in the facility, as part of the automated storage and retrieval system. The facility may include container processing stations, also referred to as tote processing stations or workstations, where containers, or totes, may be inducted into or dispensed from the automated storage and retrieval system. These containers may be transferred at the container processing stations to and from the mobile robots.

In one aspect, and without limitation, this disclosure may generally relate to the induction of items into totes to be stored in a storage structure within an automated storage and retrieval system. In some forms, an identifier associated with items of an order may be scanned and the items, residing in bags, are temporarily held in a buffer storage. Scanning the identifier may cause the automated storage and retrieval system to transport a partially filled tote, if available, to a workstation, and the items may be consolidated into fewer bags and transported to the partially filled tote. This may result in a lower number of totes per order, lower wait times when retrieving the totes associated with the order and reduced mobile robot traffic. This may also result in lower wait times for customers picking up an order, a reduced number of bags in the order, and a reduced pre-staging area.

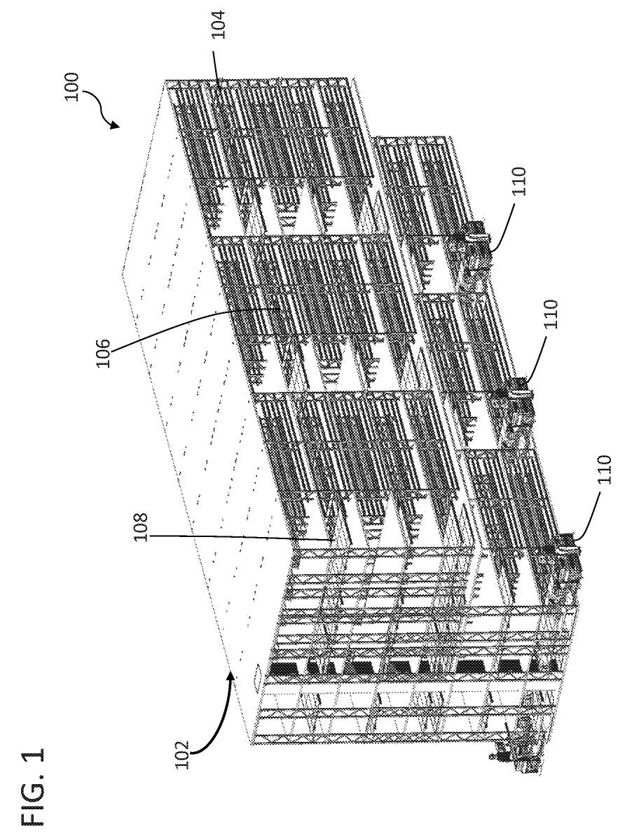

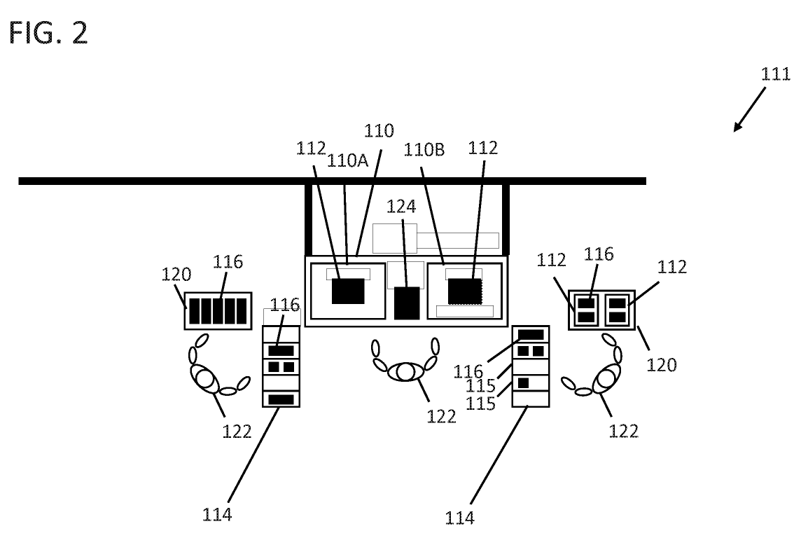

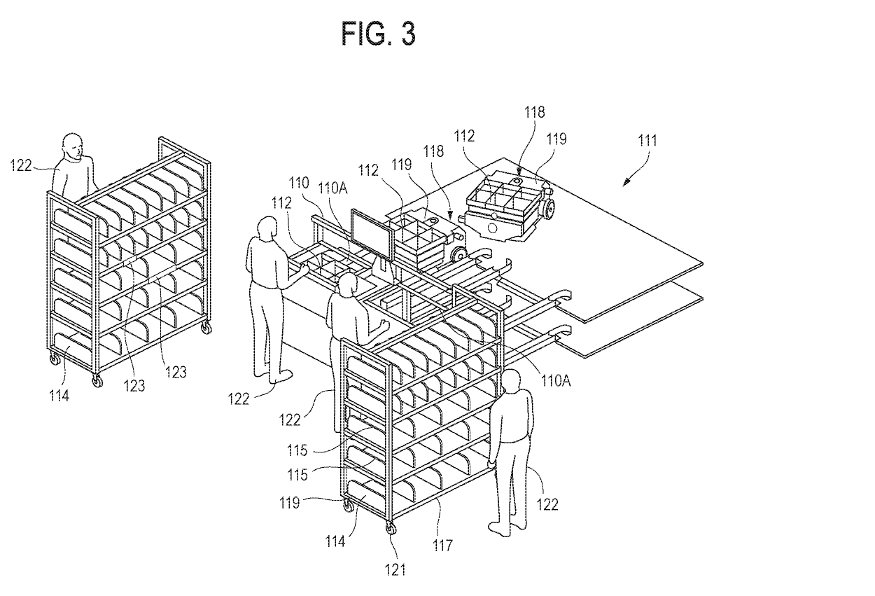

FIG. 1 shows parts of a retail facility 100 (or storage facility) that utilizes an automated storage and retrieval system (ASRS) in accordance with some embodiments. More specifically, as part of the ASRS, FIG. 1 shows a storage structure 102 that is generally intended to store various items at a number of storage locations 104. In some embodiments, the storage structure 102 includes a plurality of levels that are vertically separated, and aisles 106 extending along each of the levels. The aisles 106 may include a plurality of storage locations 104 each configured to receive and store a tote (such as the totes 112 shown in FIG. 2). In one form, the storage structure 102 may include a y-z array of storage locations 104 in horizontal rows and climbing channels (which also may be referred to as vertical towers or level changing towers) along the rows. Rows of storage locations 104 may be arranged to face each other, separated by horizontal pathways or aisles 106. Generally, in the illustrated embodiment, the storage structure 102 includes a plurality of totes 112, generally stored in the storage locations 104, and a transport system (such as the transport system 118 shown in FIG. 3) configured to move totes 112 within the storage structure 102. In some forms, the transport system 118 includes mobile robots 119 which may travel between storage levels in the z-direction within the climbing channels. In some embodiments, the mobile robots 119 are configured to move laterally along the aisles 106 and vertically through the plurality of levels to retrieve and move the totes 112 stored within the storage structure 102. In some aspects, as part of the ASRS, the retail facility 100 may include additional and/or alternate mechanisms (e.g., of the transport system 118) including shuttles, lifts, and so forth.

The storage structure 102 may further include decks 108 (which may also be referred to as transit planes or areas) spaced apart at different horizontal levels of the storage structure 102. The decks 108 may extend between the aisles 106 so that mobile robots can maneuver in the x-y plane of each deck 108 to travel between different aisles 106. Further details relating to the general structure and operation of embodiments of storage structures and mobile robots, such as may be used in conjunction with this disclosure, are disclosed in U.S. Patent No. 9,139,363, issued September 22, 2015, entitled “Automated System for Transporting Payloads;” U.S. Patent No. 10,040,632, issued August 7, 2018, entitled” Automated System for Transporting Payloads;” U.S. Patent 10,435,241, issued October 8, 2019, entitled “Storage and Retrieval System;” U.S. Patent No. 10,952,533, issued March 23, 2021, entitled “Modular Structure for an Automated Storage and Retrieval System;” and U.S. Patent No. 11,142,398, issued October 12, 2021, entitled “Order Fulfillment System;” which patents are all incorporated by reference herein in their entirety.

FIG. 1 further shows workstations 110 (also referred to herein as container processing stations) at the retail facility 100 in accordance with some embodiments. In some embodiments, the workstations 110 are connected to the storage structure 102 (but the workstations 110 may be separate and distinct from the storage structure 102 in some embodiments). In one form, operators (human individuals and/or robotic operators) work at the workstation 110. Various operations may be performed at the workstations 110. The transport system 118, which may include one or more mobile robots 119, may perform transport operations, including moving totes 112 between storage locations 104 and the workstations 110, and including transporting the totes 112 away from the workstation 110. Examples of workstations 110 and picking and transfer operations, such as may be used in conjunction with this disclosure, are disclosed, for example, in U.S. Patent No. 11,845,610, issued December 19, 2023, entitled “Automated Decant System;” U.S. Patent Publication No. 2021/0380343, published December 9, 2021, entitled “Robotic Each Picking in a Micro-Fulfillment Center;” and U.S. Patent No. 10,984,375, issued April 20, 2021, entitled “Picking Workstation with Mobile robots and Machine Vision Verification of Each Transfers Performed by Human Operators;” all of which are incorporated by reference herein in their entirety.

FIGS. 2 and 3 show a system 111 of item induction at a workstation 110 in accordance with some embodiments. The system 111 generally includes a workstation 110 configured to perform the actions described above. In the embodiment shown, the workstation 110 includes two tote processing stations 110A, 110B each configured to engage with a tote 112 when performing various operations. In some embodiments, the workstation 110 further includes a bag processing station 124 that facilitates a consolidation of items 116 into the bags to reduce the number of bags that are needed to contain the items 116 of an order. The bag processing station 124 may include any suitable features including, surfaces, bag holders, bags, etc., configured to aid in the consolidation process of items 116 into the bags. As shown in FIG. 2, the two tote processing stations 110A and 110B each include a tote 112 accessible from the tote processing stations 110A and 110B. The system 111 further includes carts 120 configured to hold items 116 and/or totes 112. The system 111 further includes buffer storages 114 configured to hold items 116. In some embodiments, operators 122 (which may be robotic or human) transfer the items 116 throughout the system 111 (e.g., place items 116 into the totes 112, pick items 116 out of totes 112, etc.).

In some embodiments, the totes 112 are any suitable container, bin, box, etc., configured to store items 116. The items 116 may include various products that may be offered for sale or stored at the retail facility 100. In some embodiments, the items 116 located within the totes 112 are contained inside of bags. In some aspects, the items 116 within the totes 112 are individually placed into the totes 112 without being bagged. In some embodiments, there may be multiple bags (e.g., 2, 3, 4, 5, or more bags) needed to contain all of the items 116 (e.g., 5, 8, 10, or more items) of a single order, and the number of bags holding the items 116 of an order may be consolidated at the bag processing station 124 to reduce the number of bags that are required to retain all of the items 116 of one order. The totes 112 may have any suitable dimensions, features, configurations, etc., however, in preferred forms, the totes 112 are configured to be compatible with and fit into a corresponding location for a tote 112 of the mobile robots 119 of the transport system 118, the storage locations 104, and/or the tote processing stations 110A, 110B of the workstations 110.

In some embodiments, the buffer storages 114 are configured to store items 116 prior to the items 116 being placed into the totes 112 at the workstation 110. The buffer storages 114 may be any suitable table, shelving unit, cart, consolidation wall, etc., suitable for temporarily holding the items 116. In some forms, the buffer storage 114 is a consolidation wall including spaces configured to hold the items 116 from a plurality of orders in a plurality of levels, and the spaces are configured to be accessed from at least a first side 117 and a second side 113 of the consolidation wall. Generally, the first side 117 is configured to receive the items 116 and the second side 113 is configured to have the items 116 removed from, though it is generally contemplated that any alternate function can be used for either the first side 117 and/or the second side 113.

In some embodiments, the buffer storage 114 is configured to be accessible by an operator 122 on opposite sides 113, 117 of the buffer storage 114. The buffer storage 114 may include multiple vertical levels of buffer spaces 115 where the items 116 may be placed. The buffer spaces 115 may have any combination of variable and/or identical dimensions as one another. The buffer storage 114 may further include a plurality of location identifiers (e.g., barcodes), each of the identifiers being associated with a respective buffer space 115 within the buffer storage 114. In some embodiments, an operator 122 may scan an order identifier of an order and/or the items 116 of the order and may scan a location identifier of one or more buffer space(s) 115 to associate one or more buffer space(s) 115 with the items 116 of the order. In some aspects, for example, an operator 122 on the first side 117 of the buffer storage 114 may scan location identifiers and place items 116 into respective buffer spaces 115 on the first side 117 of the buffer storage 114. In some aspects, for example, an operator 122 on the second side 113 of the buffer storage 114 may retrieve items 116 from the second side 113 of the buffer storage 114 and/or perform operations with the retrieved items 116 at the workstation 110.

In some embodiments, the buffer storage 114 includes ancillary mechanisms including motors, sensor, power sources, wheels, etc., configured to perform a variety of functions. In some forms, the buffer storage 114 is disposed on wheels 121 configured to transport the buffer storage 114 within the retail facility 100. In some embodiments, the wheels may be manual wheels (i.e., the buffer storage 114 requires an external force to move), and/or may be motorized wheels (i.e., the buffer storage 114 does not require an external force to move). In some embodiments, the buffer spaces 115 of the buffer storage 114 include one or more sensors positioned to detect the presence of the items 116 in the buffer spaces 115 and configured to indicate if the items 116 are detected in respective buffer spaces 115.

In some forms, the buffer storage 114 includes one or more indicator lights 123 configured to light up the buffer spaces 115 of the buffer storage 114 on either and/or both sides. In some embodiments, the indicator lights 123 light up to indicate to an operator 122 that the items 116 in the buffer space(s) 115 belong to the same order. Further, the indicator lights 123 may light up to indicate that there is a tote 112 at the workstation 110 for the items 116 of an order to be placed into. In some embodiments, a power source may be coupled to the buffer storage 114 and/or to ancillary mechanisms of the buffer storage 114 described above in order to supply power to the mechanisms (e.g., motorized wheels, sensors, lights, etc.). While only a few representative indicator lights 123 are illustrated in FIG. 3, in some embodiments, there may be a separate indicator light for each buffer space 115 on both sides of the buffer storage 114. In some embodiments, the indicator lights 123 on either side of the buffer storage 114 are independently illuminated to provide different indications to the operator putting items 116 into the buffer storage 114 and the operator retrieving items from the buffer storage 114.

In some embodiments, the carts 120 may be any suitable movable devices configured to accommodate the items 116 thereon and to transport the items 116 to/from the workstations 110 and/or to/from the buffer storages 114. For example, the carts 120 may be utility carts, shopping carts, and/or any other suitable alternate carts. The carts 120 preferably include wheels in order to allow the carts 120 to be transported (by a human operator, a built-in driving mechanism, an attached robot, etc.) throughout the retail facility 100. The carts 120 may be configured to hold any combination of individual unbagged items 116, bagged items 116, and/or totes 112 containing bagged items 116 and/or individual unbagged items 116. In some embodiments, the item induction to the automated storage and retrieval system is the context of an order fulfillment process, and the carts 120 are configured to be used by an operator 122 in an item picking process. The item picking process may be performed in a retail facility 100 (e.g., in a backroom, on a sales floor, etc.) and the items 116 corresponding to a plurality of orders may be picked and placed onto the cart 120 to further undergo item induction into the storage structure 102. In preferred embodiments, the carts 120 may be brought (by a human operator, a built-in driving mechanism, an attached robot, etc.) into position nearby the buffer storage 114 so that an operator 122 may transfer the items 116 from the carts 120 to the buffer storage 114.

In some embodiments, the operators 122 include any combination of human and/or robotic operators. For example, an operator 122 may be a worker at the retail facility 100 tasked to manually complete any of the actions described herein. In some forms, an operator 122 may be any robotic arm(s) and/or other mechanical system configured to complete any of the actions described herein. In some embodiments, the operators 122 transfer the items 116 from the carts 120 into the buffer storage 114 and/or from the buffer storage 114 to the workstation 110. While the embodiment in FIG. 2 shows three operators 122, and the embodiment in FIG. 3 shows four operators 122, it is generally contemplated that any alternate suitable number and/or configuration of operators 122 may be utilized.

FIG. 3 shows the system 111 described above with reference to FIG. 2 and further including a transport system 118. In the embodiment shown in FIG. 3, the transport system 118 is in the form of two mobile robots 119 which are actively transporting the totes 112. While only two mobile robots 119 are shown in FIG. 3, it will be appreciated that the transport system 118 may include any suitable number of mobile robots 119. In some aspects, the mobile robots 119 enter the workstation 110 or position themselves adjacent the workstation 110 to deposit a tote 112 directly into a tote processing station 110A, 110B and/or to receive the tote 112 directly from the tote processing station 110A, 110B. In some embodiments, the workstation 110 and the tote processing stations 110A, 110B are static and not configured to perform any actions involving receiving and/or depositing a tote 112. Further, the mobile robots 119 of the transport system 118 may be configured to deposit the totes 112 directly to the tote processing stations 110A, 110B of the workstation 110 and/or to retrieve the totes 112 directly from the tote processing stations 110A, 110B of the workstation 110. In some embodiments, the workstation 110 and/or the tote processing stations 110A, 110B include automated components which, upon receiving a tote 112 from a mobile robot 119 of the transport system 118, bring the tote 112 to a tote processing station 110A, 110B and/or bring the tote 112 from a tote processing station 110A, 110B to a position at the workstation 110 from which the tote 112 may be received by a mobile robot 119 of the transport system 118.

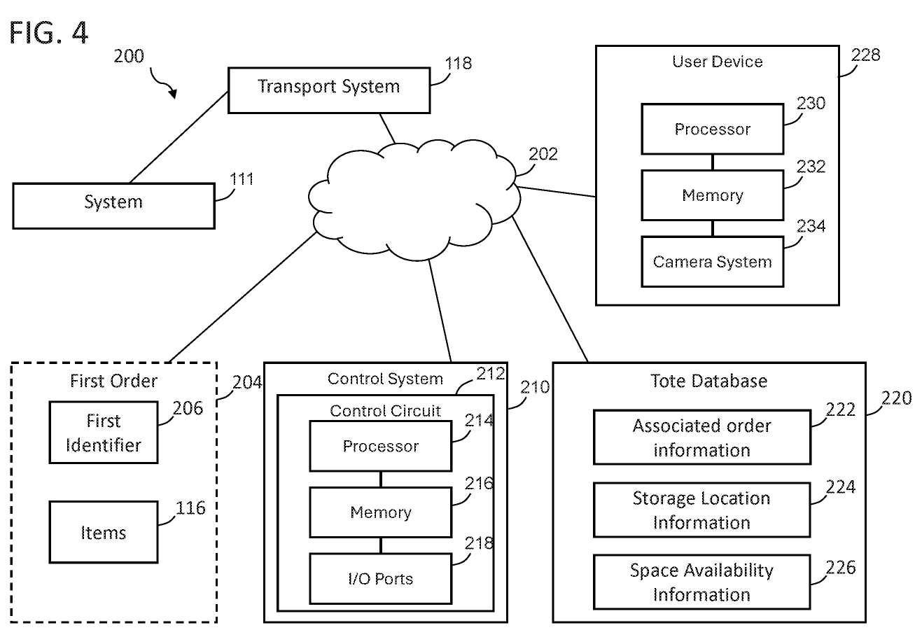

FIG. 4 shows a system 200 connected via a communication network 202. In some embodiments the system 200 may receive a first order 204, and includes a control system 210, a tote database 220, a transport system 118, and/or a user device 228. Generally, the system 200 cooperates with the system 111 via the transport system 118 in order to facilitate item induction into a storage structure 102 of an automated storage and retrieval system.

In some embodiments, the first order 204 is an order placed by a customer for one or more items 116 stocked at the retail facility 100. In some embodiments, the retail facility 100 is associated with a website and/or a software-based application accessible to a customer (e.g., by being downloaded onto a computing device of the customer). The customer may be able to place an order via the website and/or the application. In some embodiments, the retail facility 100 is an order fulfillment facility configured to fulfill and ship orders placed by customers, while in some aspects, the retail facility 100 is a retail store configured to fulfill orders placed by customers to be picked up from the retail store. Generally, the order may be placed by a customer in any suitable way and may be received by the customer in any suitable way.

In some embodiments, the first order 204 includes a first identifier 206 associated with the first order 204. The first identifier 206 associated with the first order 204 may be an order number, order barcode, and/or any alternate suitable identifier configured to be identifiable by the control system 210. In some forms, the first identifier 206 is a product identifier, a tote identifier, or an order identifier. In certain aspects, the first identifier 206 is unique to the first order 204. In some forms, the first order 204 further includes one or more items 116 of the first order 204. Generally, the items 116 may be the same and/or similar to the items 116 described above. In some embodiments, the items 116 of the first order 204 are a subset of the items 116 stocked/offered for sale at the retail facility 100. In some aspects, the first order 204 is received by the user device 228 and uploaded to the tote database 220 via the communication network 202. In some embodiments, the first order 204 is uploaded to the system 200 from any alternate application, device, server, etc., and may be stored in the tote database 220, any alternate database, and/or any alternate storage location.

In some embodiments, the tote database 220 is configured to store electronic data including associated order information 222, storage location information 224, and space availability information 226. In some embodiments, the associated order information 222 may include the first order 204, an identifier of the first order 204 (such as the first identifier 206), the items 116 of the first order 204, any totes 112 in the storage structure 102 already associated with the first order 204 and, in some forms, information regarding a subset of items 116 of the first order 204. In some forms, the associated order information 222 includes customer information (e.g., name of customer placing the order, name of person picking up the order from the retail facility 100 etc.), fulfillment means of the order (e.g., pickup, delivery, shipping, etc.), etc. In some embodiments, the space availability information 226 of the totes 112 and the space availability of a tote 112 is based on the space occupied by the items 116 stored in one or more of the totes 112. Space availability of a tote 112 may be determined based on known dimension information of the items 116, which may be stored in the tote database 220 in some embodiments. In some embodiments, the storage location 104 of a tote 112 is stored as part of the storage location information 224 stored in the tote database 220. In some implementations, the tote database 220 stores any additional and/or alternate information that may be useful to the control system 210 and/or to an operator 122 during an item induction process.

In some embodiments, the system 200 further includes a user device 228. In some forms, an operator 122 may use a user device 228 to scan the location identifier of a buffer spaces 115 and/or an order identifier (such as the first identifier 206 of the first order 204). The user device 228 may be any smart phone, tablet, scanner, etc., which generally includes and/or is coupled to a device including a processor 230 and memory 232. In the embodiment illustrated in FIG. 4, the user device 228 includes a camera system 234 configured to scan any suitable identifiers (e.g., an identifier of a buffer space 115, the first identifier 206 of the first order 204, etc.). In some embodiments, an application may be run via the processor 230 of the user device 228 with application data being saved in the memory 232. In some embodiments, the application may prompt an operator 122 to scan an identifier, and may further send, via the communication network 202, the identifier scanned by the user device 228 to the control system 210. In some embodiments, the identifier sent to the control system 210 is the same identifier that was scanned by the user device 228, while in some aspects, the identifier sent to the control system 210 is a new identifier (such as the first identifier 206) generated by the processor 230 in response to the initial identifier being scanned by the user device 228. The application described may, for example, be an application configured to facilitate order fulfillment within a retail facility 100.

In some embodiments, the control system 210 includes a control circuit 212 (which may be referred to herein as a “controller”) which further includes a processor 214, a memory 216, and any suitable input/output ports 218. In some forms, the movement of the mobile robots 119 of the transport system 118 of the automated storage and retrieval system may be controlled by the control circuit 212 of the control system 210. In this context, the terms control circuit and controller refer broadly to any microcontroller, computer, or processor-based device with processor, memory, and programmable input/output peripherals (such as the processor 214, memory 216, and/or the input/output ports 218), which is generally designed to govern the operation of other components and devices. It is further understood to include common accompanying accessory devices, including memory, transceivers for communication with other components and devices, etc. These architectural options are well known and understood in the art and require no further description here. The control circuit or controller may be configured (for example, by using corresponding programming stored in a memory as will be well understood by those skilled in the art) to conduct one or more of the steps, actions, and/or functions described herein.

In some embodiments, the control system 210 is configured to receive a first identifier 206 associated with a first order 204 indicating that the items 116 in the first order 204 have been placed into the buffer storage 114. In some embodiments, the items 116 of a first order 204 may be placed in totes 112 and/or bags onto a cart 120. In some embodiments, an order 204 may contain more items 116 than what is on the carts 120 and/or associated with the first identifier 206. For example, there may be any combinations of items 116 of the first order 204 in totes 112 in the storage structure 102, on carts 120, on a sales floor of the retail facility 100, etc. The first identifier 206, in the described embodiment, is exclusively associated with the items 116 of the first order 204 awaiting induction into the storage structure 102.

In some aspects, an operator 122 may scan (e.g., with the camera system 234 of the user device 228) an identifier (which may, for example, be a barcode on a bag, a tote 112, etc.) which is associated with the items 116 of the first order 204 on the carts 120. After scanning the identifier, the operator 122 may scan a location identifier of at least one buffer space 115 and place the items 116 of the first order 204 into the respective buffer space(s) 115. Depending on the number and size of the items 116 in the first order 204, any number of buffer spaces 115 may be used. After the items 116 have been placed into the buffer spaces 115, the user device 228 may generate and/or send the first identifier 206 to the control system 210. In the described embodiment, the first identifier 206 includes information associated with the subset of the items 116 of the first order 204 that is stored in the buffer storage 114, and which buffer spaces 115 the items 116 are located at.

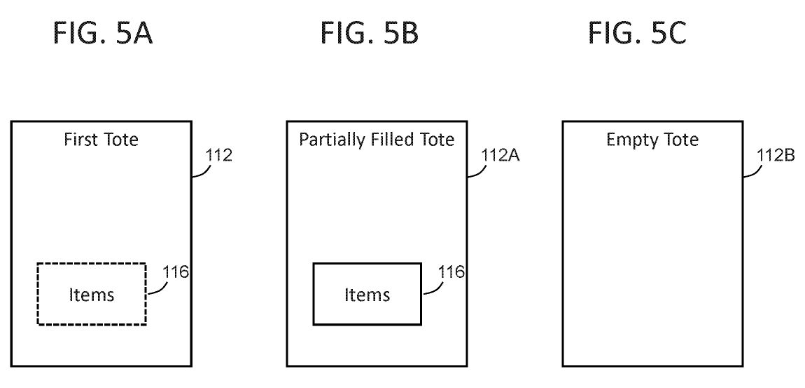

FIG. 5A schematically shows a first tote 112 associated with the first order 204. Generally, the first tote 112 holds the items 116 of the first order 204. In FIG. 5A, the box around the items 116 is shown as a dashed line to signify that the first tote 112 could be empty or could be partially filled with items 116 of the first order 204. FIG. 5B schematically shows a partially filled tote 112A containing the items 116, and FIG. 5C shows an empty tote 112B containing no items 116. It is generally understood that the first tote 112, the partially filled tote 112A, and/or the empty tote 112B may be the same or similar to the totes 112 described herein. In some embodiments, the first tote 112 may be either a partially filled tote 112A or an empty tote 112B. Any combination of empty totes 112B and partially filled totes 112A may be used to hold the items 116 corresponding with an order.

In some embodiments, the control system 210 is configured to select, in response to receiving the first identifier 206, a first tote 112 from the storage structure 102 for the first order 204 based on associated order information 222 and space availability information 226 of the totes 112. Further, the control system 210 may be configured to access the data in the tote database 220 to determine if there is a partially filled tote 112A associated with the first order 204, and to determine if the partially filled tote 112A has space to store the items 116 in the first order 204 located in buffer spaces 115 of the buffer storage 114. This step may be optional.

In some embodiments, the tote database 220 stores item data which may include dimensions for the various items 116 in the retail facility 100. In some forms, the items 116 of the first order 204 in a partially filled tote 112A and the dimension information of the items 116 in the partially filled tote 112A are stored in the tote database 220 and are accessible by the control system 210. Further, the items 116 of the first order 204 in the buffer storage 114 and the dimension information of the items 116 in the buffer storage 114 may be stored in the tote database 220 and are accessible by the control system 210. The control system 210 may be configured to determine, based on the dimensions of the items 116, the space availability in the partially filled tote 112A, and determine if there is space in the partially filled tote 112A for the items 116 associated with the first order 204 and located in the buffer storage 114. When there is a partially filled tote 112A that is associated with the first order 204 and that has available space for the items 116 stored in the buffer storage 114, the control system 210 will select the partially filled tote 112A as the first tote 112. If there is no partially filled tote 112A associated with the first order 204, or if all of the partially filled totes 112 associated with the first order 204 lack the space availability to store the items 116 of the first order 204 located in the buffer storage 114, the control system 210 selects an empty tote 112B as the first tote 112.

In some forms, the control system 210 is configured to cause a mobile robot 119 of the transport system 118 to retrieve the first tote 112 from the storage structure 102 and transport the first tote 112 to the workstation 110 based on a storage location 104 of the first tote 112. In some embodiments, the control system 210 may receive storage location information 224 information from the tote database 220 via the communication network 202 and guide the mobile robot 119 of the transport system 118 to the location of the first tote 112 selected by the control system 210 for retrieval from the storage structure 102. In some embodiments, each of the mobile robots 119 of the transport system 118 is coupled to the control system 210 via the communication network 202, and the control system 210 is configured to control the mobile robots 119 of the transport system 118 remotely via the communication network 202. In some forms, each of the mobile robots 119 of the transport system 118 is directly coupled to the control system 210 via the input/output ports 218 of the control system 210. Generally, each of the mobile robots 119 of transport system 118 is configured to move along the levels, aisles 106, and or decks 108 of the storage structure 102 to reach the respective storage location 104 of the first tote 112 selected by the control system 210 for retrieval from the storage structure 102. After arriving at the storage locations 104, the mobile robots 119 of the transport system 118 may retrieve the tote 112 and transport the tote 112 to the workstation 110.

In some embodiments, before the first tote 112 arrives at the workstation 110 via a mobile robot 119 of the transport system 118, the control system 210 is further configured to receive a second identifier associated with a second order indicating that the items 116 in the second order have been placed into the buffer storage 114, select a second tote 112 within the storage structure 102 for the second order, and cause a mobile robot 119 of the transport system 118 to begin transporting the second tote 112 to the workstation 110. In some embodiments, by having a queue of totes 112 being transported to the workstation 110 for a plurality of orders (i.e., a second tote 112 marked for transport to a workstation 110 while a first tote 112 is actively being transported to the workstation 110), the process of item induction decreases the amount of time between a time when the first tote 112 for the first order 204 has arrived at the workstation 110 and a time when a mobile robot 119 of the transport system 118 is dispatched by the control system 210 to pick up the second tote 112 and transport the second tote 112 to the workstation 110. It will be appreciated that any number of identifiers associated with an order may be received and/or any number of totes 112 may be selected and transported to the workstation 110 before the first tote 112 arrives at the workstation 110.

In some embodiments, the control system 210 is configured to provide instructions to transfer the items 116 in the first order 204 from the buffer storage 114 to the first tote 112 after the first tote 112 arrives at the workstation 110. In some forms, the instructions are provided to an operator 122 via the user device 228, and the instructions will prompt the operator 122 to remove the items 116 of the first order 204 from the buffer storage 114 and place the items 116 removed from the buffer storage 114 onto the first tote 112 located at the workstation 110. In some embodiments, when the operator 122 scans the location identifier(s) of the buffer space(s) 115 that store the items 116 associated with the first order 204, the control system 210 receives a buffer space identifier, which indicates the location of the items 116 in the buffer storage 114. The location of the items 116 in the buffer storage 114 may include an identification of the buffer space(s) 115 the items 116 are stored in. Further, in some forms, the instructions to transfer the items 116 may include an indication of the location of the items 116 in the buffer storage 114 associated with the buffer space identifier. In some embodiments, the buffer storage 114 includes one or more indicator lights 123 each associated with a buffer space 115 within the buffer storage 114. In some forms, the instructions sent by the control system 210 to transfer the items 116 in the first order 204 from the buffer storage 114 to the first tote 112 may cause illumination of one or more indicator lights 123 associated with one or more buffer spaces 115 holding the items 116 of the first order 204.

In some forms, the control system 210 is configured to cause the mobile robot 119 of the transport system 118 to transfer the first tote 112, along with the items 116 in the first order 204, from the workstation 110 to the storage structure 102 for storage. In some forms, the items 116 in the first tote 112 represent only a subset of all of the items 116 of the first order 204. The automated storage and retrieval system may be configured to hold the items 116 in corresponding totes 112 within the storage locations 104 of the storage structure 102 until all of the items 116 of the first order 204 are located in corresponding totes 112. In some embodiments, after all of the items 116 of the first order 204 have been placed into corresponding totes 112, mobile robots 119 of the transport system 118 may transport the corresponding totes 112 of items 116 to a separate workstation 110, where the items 116 may be removed from the totes 112 and placed into one or more bags and/or placed directly onto carts 120 without being bagged. In some embodiments, the items 116 of the first order 204 may be consolidated from the corresponding totes 112 into one or more bags, and dispensed (e.g., via shipping, via store pickup, etc.) to a customer that placed the first order 204 to another person indicated in the first order 204.

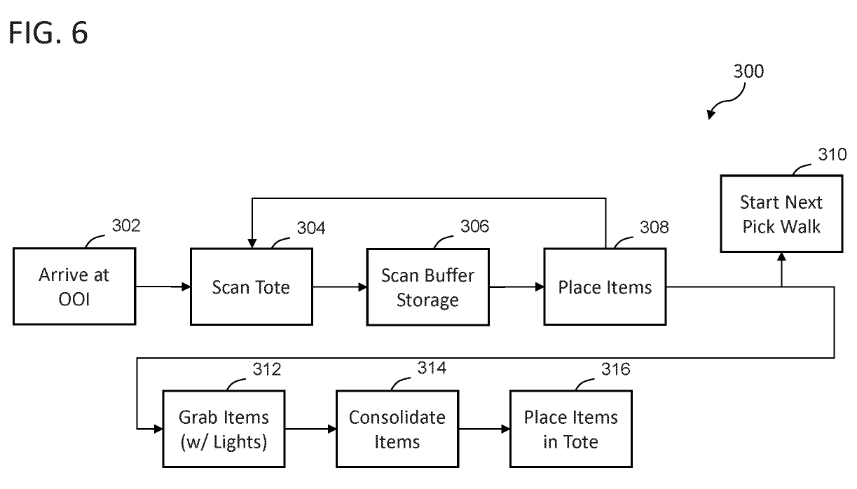

FIG. 6 shows an example process 300 of item induction performable by an operator in accordance with some embodiments. In accordance with some aspects, the process 300 may be performed by an operator of an automated storage and retrieval system within a retail facility 100. It is generally contemplated that the process 300 may use some or all of the components described above, such as, for example, components of the system 111 and the system 200.

At block 302, items corresponding with a plurality of orders arrive at a buffer storage of an offline order induction system (OOI). The items may be inside of totes, and each of the totes may be associated with a specific order. Generally, each tote has an identifier associated with the items inside of the tote and the order associated with the items. At block 304, an operator scans the identifier of a tote. Any suitable device may be used to scan the identifier on the tote, such as a user mobile device, a scanner, etc. At block 306, the operator scans a location identifier of a buffer space within the buffer storage. At block 308, the operator takes the items in the scanned tote, and places them into the buffer space corresponding to the location identifier scanned. The steps at blocks 304, 306, and 308 are generally repeated until there are no more totes, and no more items located adjacent to the buffer storage. At block 310, an operator may go pick additional items corresponding to a plurality of orders when there are no more totes, and no more items located adjacent to the buffer storage.

At block 312, after a tote corresponding with an order has arrived at a workstation, indicator lights on the buffer storage at the buffer space(s) corresponding with the order will illuminate. An operator then picks (i.e., removes) the items from the indicated buffer space(s) and brings them to the workstation. At block 314, an operator consolidates the items into a fewer number of bags. Generally, after arrival near the buffer storage, the items of an order are in a multiple bags (e.g., an order with eight items may be in five bags, some of which contain only one item). At block 316, after the items have been consolidated into fewer bags, the bags of items are placed into the tote. The steps at blocks 312, 314, and 316 are generally repeated for as long as needed.

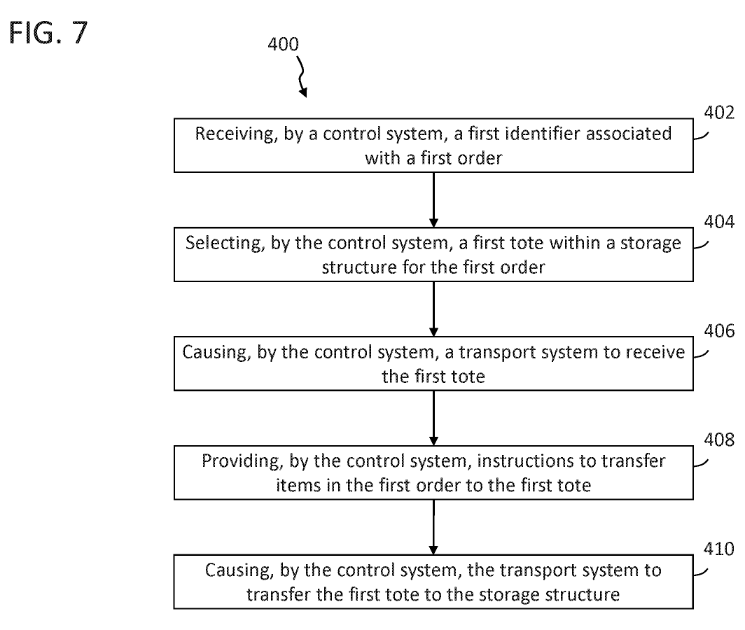

FIG. 7 shows an example process 400 of item induction performable by a control system in accordance with some embodiments. In some aspects, the process 400 may be performed via an automated storage and retrieval system within a retail facility. It is generally contemplated that the process 400 may use some or all of the components described above, such as, for example, components of the system 111 and the system 200.

At block 402, the process 400 includes receiving, by a control system of the automated storage and retrieval system, a first identifier associated with a first order. The first identifier generally indicates that items in the first order have been placed into a buffer storage. In some forms, the control system further includes a control circuit. In some forms, the first identifier is a product identifier, a tote identifier, or an order identifier. In some embodiments, the buffer storage includes a consolidation wall further including spaces (e.g., buffer spaces) configured to hold items from a plurality of orders in a plurality of levels. Generally, the spaces are configured to be accessed from at least a first side and a second side of the consolidation wall. In some forms, the buffer storage includes a plurality of location identifiers each associated with a buffer space within the buffer storage. The control system may further receive a buffer space identifier indicating a location of the items within the buffer storage.

At block 404, the process 400 includes selecting, by the control system, in response to receiving the first identifier, a first tote, within a storage structure storing a plurality of totes, for the first order. In some forms, the first tote is selected based on associated order information and space availability information, and the space availability of a tote is based on space occupied by items stored in the tote. In some embodiments, a tote database stores the associated order information, the space availability information, storage location information, and/or any additional information relevant to the process 400. In some forms, the process 400 further includes, by the control system and the tote database, determining if there is a partially filled tote associated with the first order based on the information stored in the tote database, and determining whether the partially filled tote has the space to store the items in the first order in the buffer storage. In some forms, if the partially filled tote associated with the first order has the space for the items in the buffer storage, the partially filled tote is selected as the first tote. Further, if no partially filled tote is previously associated with the first order, or if all partially filled totes lack the space availability to store the items in the first order in the buffer storage, an empty tote is selected as the first tote.

At block 406, the process includes causing, by the control system, a transport system to retrieve the first tote from the storage structure and transport the first tote to a workstation connected to the storage structure based on a storage location of the first tote within the storage structure. In some forms, the transport system is configured to move totes within the storage structure and to and from workstations. In some aspects, the storage structure includes a plurality of levels that are vertically separated, and aisles extending along each of the levels. Each aisle of the aisles generally includes a plurality of storage locations configured to receive and store a tote. The process 400 may further include, by mobile robots of the transport system, moving laterally along the aisles and vertically through the plurality of levels to retrieve and move the plurality of totes stored within the storage structure.

In some embodiments, before the first tote arrives at the workstation, the process 400 may further include, receiving, by the control system, a second identifier associated with a second order indicating that items in the second order have been placed in the buffer storage. In some form, the control system selects a second tote within the storage structure for the second order and causes the transport system to begin transporting the second tote to the workstation.

At block 408, the process includes, by the control system, providing instructions to transfer items in the first order from the buffer storage to the first tote upon the first tote arriving at the workstation. In some forms, the instructions are provided to an operator via a user device, while in some aspects the instructions are provided via a physical indicator (e.g., light) at a buffer space of the buffer storage which the items of the order reside in. In some embodiments, the instructions to transfer the items include an indication of the location (e.g., which buffer space(s)) of the items located in the buffer storage associated with the buffer space identifier described above. In some forms, the buffer storage includes a plurality of indicator lights each associated with a buffer space within the buffer storage, and the instructions to transfer the items in the first order from the buffer storage to the first tote are provided via illuminating an indicator associated with the buffer space holding the items in the first order.

At block 410, the process includes, by the control system, causing the transport system to transfer the first tote, along with the items in the first order in the first tote, from the workstation to the storage structure for storage.

The systems and methods described hereinabove advantageously facilitate efficient item induction into an automated storage and retrieval system, including intelligent selection of empty or partially filled totes, coordinated buffering of items, and streamlined operator workflows that reduce tote count, robot movements, and order-fulfillment delays.

Those skilled in the art will recognize that a wide variety of other modifications, alterations, and combinations can also be made with respect to the above described embodiments without departing from the scope of the disclosure.

1. A system for item induction to an automated storage and retrieval system, the system comprising:
a storage structure storing a plurality of totes;
a transport system configured to move the totes within the storage structure and to and from workstations;
a workstation connected to the storage structure;
a buffer storage; and
a control system comprising a control circuit that:
receives a first identifier associated with a first order indicating that items in the first order have been placed into the buffer storage;
selects, in response to receiving the first identifier, a first tote within the storage structure for the first order based on associated order information and space availability information of the plurality of totes, wherein a tote database stores the associated order information, storage location information, and wherein the space availability information of the plurality of totes and space availability of a tote is based on space occupied by items stored in the tote;
causes the transport system to retrieve the first tote from the storage structure and transport the first tote to the workstation based on a storage location of the first tote;
provides instructions to transfer the items in the first order from the buffer storage to the first tote after the first tote arrives at the workstation; and
causes the transport system to transfer the first tote, along with the items in the first order, from the workstation to the storage structure for storage.

2. The system of claim 1,
wherein the storage structure comprises:
a plurality of levels that are vertically separated; and
aisles extending along each of the plurality of levels, wherein each aisle of the aisles comprises a plurality of storage locations configured to receive and store a tote; and
wherein the transport system comprises mobile robots configured to move laterally along the aisles and vertically through the plurality of levels to retrieve and move the plurality of totes stored within the storage structure.

3. The system of claim 1, wherein before the first tote arrives at the workstation, the control system is further configured to:
receive a second identifier associated with a second order indicating that items in the second order have been placed into the buffer storage;
select a second tote within the storage structure for the second order; and
cause the transport system to begin transporting the second tote to the workstation.

4. The system of claim 1, wherein the control system is further configured to:
determine, by the control system and the tote database, if there is a partially filled tote associated with the first order in the storage structure based on information stored in the tote database; and
determine whether the partially filled tote has the space availability to store the items in the first order that are located in the buffer storage.

5. The system of claim 4, wherein if the partially filled tote associated with the first order has the space availability for the items in the first order that are located in the buffer storage, the partially filled tote is selected as the first tote.

6. The system of claim 4, wherein if no partially filled tote was previously associated with the first order, or if all partially filled totes associated with the first order lack the space availability to store the items in the first order that are located in the buffer storage, an empty tote is selected as the first tote.

7. The system of claim 1, wherein the first identifier is a product identifier, a tote identifier, or an order identifier.

8. The system of claim 1, wherein the buffer storage comprises a consolidation wall comprising:
buffer spaces configured to hold items from a plurality of orders at a plurality of vertical levels, wherein the buffer spaces are configured to be accessed from at least a first side and a second side of the consolidation wall.

9. The system of claim 1,
wherein the buffer storage comprises a plurality of location identifiers each associated with a buffer space within the buffer storage;
wherein the control system further receives a buffer space identifier indicating a location of the items in the buffer storage; and
wherein the instructions to transfer the items comprise an indication of the location of the items in the buffer storage associated with the buffer space identifier.

10. The system of claim 1,
wherein the buffer storage comprises a plurality of indicator lights each associated with a buffer space within the buffer storage; and
wherein the instructions to transfer the items in the first order from the buffer storage to the first tote are provided via illuminating an indicator light of the indicator lights that is associated with the buffer space holding the items in the first order.

11. A method for item induction to an automated storage and retrieval system, the method comprising:
receiving, by a control system of the automated storage and retrieval system, a first identifier associated with a first order indicating that items in the first order have been placed into a buffer storage, wherein the control system comprises a control circuit;
selecting, by the control system in response to receiving the first identifier, a first tote within a storage structure storing a plurality of totes for the first order based on associated order information and space availability information, wherein a tote database stores the associated order information, storage location information, and the space availability information of the plurality of totes and space availability of a tote is based on space occupied by items stored in the tote;
causing, by the control system, a transport system to retrieve the first tote from the storage structure and transport the first tote to a workstation connected to the storage structure based on a storage location of the first tote, wherein the transport system is configured to move totes within the storage structure and to and from workstations;
providing, by the control system, instructions to transfer items in the first order from the buffer storage to the first tote after the first tote arrives at the workstation; and
causing, by the control system, the transport system to transfer the first tote, along with the items in the first order, from the workstation to the storage structure for storage.

12. The method of claim 11, wherein the storage structure comprises:
a plurality of levels that are vertically separated; and
aisles extending along each of the plurality of levels, wherein each aisle of the aisles comprises a plurality of storage locations configured to receive and store a tote;
the method further comprising:
moving, by mobile robots of the transport system, laterally along the aisles and vertically through the plurality of levels to retrieve and move the plurality of totes stored within the storage structure.

13. The method of claim 11, wherein before the first tote arrives at the workstation, the method further comprises:
receiving, by the control system, a second identifier associated with a second order indicating that items in the second order have been placed into the buffer storage;
selecting, by the control system, a second tote within the storage structure for the second order; and
causing, by the control system, the transport system to begin transporting the second tote to the workstation.

14. The method of claim 11, further comprising:
determining, by the control system and the tote database, if there is a partially filled tote associated with the first order in the storage structure based on information stored in the tote database; and
determining whether the partially filled tote has the space availability to store the items in the first order that are located in the buffer storage.

15. The method of claim 14, wherein if the partially filled tote associated with the first order has the space availability for the items in the first order that are located in the buffer storage, the partially filled tote is selected as the first tote.

16. The method of claim 14, wherein if no partially filled tote is previously associated with the first order, or if all partially filled totes associated with the first order lack the space availability to store the items in the first order that are located in the buffer storage, an empty tote is selected as the first tote.

17. The method of claim 11, wherein the first identifier is a product identifier, a tote identifier, or an order identifier.

18. The method of claim 11, wherein the buffer storage comprises a consolidation wall comprising:
buffer spaces configured to hold items from a plurality of orders at a plurality of vertical levels, wherein the buffer spaces are configured to be accessed from at least a first side and a second side of the consolidation wall.

19. The method of claim 11, wherein the buffer storage comprises a plurality of location identifiers each associated with a buffer space within the buffer storage;
wherein the control system further receives a buffer space identifier indicating a location of the items in the buffer storage; and
wherein the instructions to transfer the items comprises an indication of the location of the items in the buffer storage associated with the buffer space identifier.

20. The method of claim 11, wherein the buffer storage comprises a plurality of indicator lights each associated with a buffer space within the buffer storage; and
wherein the instructions to transfer items in the first order from the buffer storage to the first tote are provided via illuminating an indicator light associated with the buffer space holding the items in the first order.
